(19) United States
(12) Patent Application Publication
(10) Pub. No.: US 2006/0113381 A1
(43) Pub. Date: Jun. 1, 2006

(54) Batteryless contact fingerprint-enabled smartcard that enables contactless capability

(76) Inventors: John Hochstein, Timonium, MD (US); Douglas Kozlay, Timonium, MD (US)

Correspondence Address: Douglas Kozlay;Suite 304, 9475 Deerco Road, Timonium, MD, 21093, US

(21) Appl. No.: 10/998,788

(22) Filed: Nov. 29, 2004

(51) Int. Cl. G06K 5/00

(52) U.S. Cl. 235/382

(57) ABSTRACT

Biometrically-enabled smartcards containing fingerprint sensors, template storage, and authentication processing require electrical power. At current state-of-the-art, biometric electronics are incompatible with radio-frequency-powered cards operating at low power levels. It's been a problem combining these technologies into one thin smartcard without adding batteries and/or recharging regimens. Disclosed is a batteryless, “contact/contactless” smartcard with built-in biometric fingerprint sensor, template storage and processor to authenticate users. The card's biometric authentication processing circuitry obtains its' initial power from contact smartcard readers, while performing authentication during card insertion. In one embodiment, the card enables contactless functions upon user entry into controlled facilities, and disables contactless functions upon egress. An external facility access control system is also disclosed, adapted for enabling/disabling “contactless” functions upon ingress/egress, and/or timing/location of card use. In high security applications, it's an option to use both contactless function enabling methods to provide additional security.

### BACKGROUND OF THE INVENTION

1. Field of the Invention

The field of the invention is security and data processing related to smartcards, more particularly, batteryless, biometrically-enabled, “hybrid” smartcards (combination contact and contactless smartcards) with additional security features for improving the protection of secured facilities.

2. Related Art

There appears to be little or no directly related art. However, a few issued US patents discuss hybrid (combination) contact and “contactless” smartcards, but most seem to focus on inter- or intra-processor switching between contact and contactless inputs.

U.S. Pat. No. 4,582,985 to Lofberg teaches a fingerprint-enabled card in which all biometric authentication functions (including sensor template storage and biometric processing) take place on the card, but Lofberg is silent on handling of contactless function enablement on a combination contact/contactless data carrier.

U.S. Pat. No. 6,168,083 to Berger, et al., describes a chip-card with mode switching between contactless and contact-coupled mode. Apparently, the chip card of the invention is operable in either a contactless or a contact-coupled mode. For operation in the contactless mode, the card has an antenna coil and rectifier and other components known in the art, comprising a rectifier circuit. In the contactless mode, the card receives an AC signal. The rectifier circuit provides a rectified received AC signal. The rectified signal is used to power the internal circuitry of the chip card. The card also has a recognition circuit that recognizes whether an AC signal is actually received by the antenna coil. If the AC signal is recognized, the recognition circuit switches the chip card to contactless mode. If no AC signal is recognized, the recognition circuit switches the chip card to the contact-coupled mode.

While this patent and products it addresses appear utilitarian as intended, this patent does not appear to address or directly compare to the technology of the present invention. This patent claims the detection of AC power on the contactless circuit by providing a switch that exclusively selects the contactless input over contact inputs (the normal default in absence of AC power). In one embodiment of the present invention, two data processors are provided, to permit independent, simultaneously operable contactless and contact functions. Apparently the chip-card (smartcard) of Berger's invention operates in a mutually exclusive manner; i.e., his card can operate either in contactless mode, or can operate in a contact-coupled mode. In further comparison, the present invention is capable of simultaneously operable contact and contactless functions only after the card's user has been biometrically authenticated, after the biometrically-authenticated user and card are present together within a controlled facility—and only when the user and card are within areas they are explicitly authorized access, at times they are explicitly authorized access, and/or only in accordance with other (situational) defined requirements of any particular controlled facility.

U.S. Pat. No. 6,375,082 to Kobayashi, et al., describes a portable electronic device with “contact” and “contactless” interfaces. The contact interface includes contact terminals for exchanging driving power and data. The contactless interface includes means for generating electrical power and demodulating received data from a signal received via an antenna. The invention also includes an inhibiting option for inhibiting simultaneous operation of one or both contact and contactless interfaces when necessary or required, while the device is driven via one of the contacting and non-contacting interfaces.

While this patent makes a contribution to the art, it does not directly compare to technology of the present invention. In the Kobayasi patent, only one processor is used which is monitoring both contact and contactless input sources. The present invention uses at least one processor or uses a multiple-processor configuration.

The patent claims an arbitration device which resolves processor memory access conflicts, in order to prevent errors in the processor memory due to possible conflicting demands between contact and contactless sources.

This patent is not analogous to the present invention because it essentially deals with arbitration (switching logic) between contact and contactless functions within the processor of a portable electronic device.

By contrast, the present invention is indifferent to processor handling of data and arbitration between contact and contactless inputs, and is also indifferent as to whether one or more processors are used to implement these functions. Instead, the present invention can enable both functions simultaneously (assuming it's programmed to do so) only after biometric authentication is successfully completed, irrespective of the processing of the contact-reader-originated commands and/or contactless-reader-originated commands. Depending on implementation details, “enabling” in the present invention can take place either electronically on the smartcard and/or can take place externally via a security access control system (a.k.a., a “security panel” such as panel 56, as described in FIG. 9). Generally, in the present invention, both contact and contactless features are operable only after users authenticate themselves biometrically, simultaneous with card insertion into an ingress smartcard reader. Since different users have different levels of access privileges, each user's own card can “help enforce” any “in-place” intra-facility security policies; e.g., a user's card may be “deactivated” automatically and/or by command (from a security control panel or infrastructure) upon entering a “restricted zone” within the controlled facility for which that user has no access privileges.

U.S. Pat. No. 6,474,558 to Reiner discloses a contact/contactless smartcard. A card is provided which includes both contact and contactless circuitry, as well as a switch for applying power obtained from the contact circuitry to the contactless circuitry. The disclosed invention has contact and contactless processor components, whereby power and clock-signals for the contact components comes through the electrical smartcard contacts, and power and clock-signals for the contactless components comes from either a received, rectified RF signal or from the smartcard contacts.

By comparison, the present invention is indifferent to the means by which processor components obtain their power, but instead, enables both contact and contactless processor components, but only after completion of successful biometric authentication by at least one biometrically authenticated user.

### Necessity of the Invention

Based on the foregoing, there is a need in the art for a batteryless, biometrically-enabled, contact/contactless smartcard with additional security characteristics, options, features, and benefits offered by the present invention. The above, indirectly-related art is useful, however, the aforementioned art does not teach the critical features of the present invention, nor does the related art offer directly comparable functionality to the critical features of present invention.

### Objects of the Invention

Accordingly, it is an object of the present invention to provide a batteryless smartcard that derives electrical power for biometric authentication from a smartcard reader, plus, also derives power for contactless functions when it enters the electromagnetic field of a contactless smartcard reader.

It is another object, to provide a combination contact/contactless smartcard—i.e., a “hybrid” smartcard—which has “ingress enabling” of its' contactless functions after an authorized user has authenticated and entered the perimeter of a controlled facility—and which has “egress disabling” of said contactless functions after an authorized user leaves the perimeter of the controlled facility.

It is another object, to provide a hybrid smartcard that's operable as both a “contact” smartcard and a “contactless” smartcard, once a user has successfully biometrically authenticated upon ingress into a controlled facility.

It is another object, to provide a smartcard which includes a communications subsystem comprising an RFID (antenna and/or transponder) loop for providing contactless functions, but only after a user has successfully authenticated themselves upon ingress contact with an ingress smartcard reader.

It is another object, to provide a smartcard with includes an optional security feature that triggers an alarm and/or exception condition if the RFID loop is (erroneously) already enabled upon a user's ingress to a controlled facility.

It is yet another object, to provide an operationally adaptable smartcard, which can by default execute biometric authentication on the smartcard, and/or which can alternatively defer biometric authentication to an ingress smartcard reader (or other authentication device) equipped with biometric authentication capabilities.

### SUMMARY OF THE INVENTION

The present invention discloses and provides improvements in technology for combination (aka, “hybrid” contact/contactless) smartcards. The present invention adds biometric fingerprint recognition capability to such multi-function smartcards, without adding a conventional battery (i.e., the card is batteryless). Before the present invention, conventional combination contact/contactless smartcards did not implement biometrics, despite that biometric security is increasingly sought by commercial, military, government, and other security-conscious buyers.

The present invention allows an authorized, enrolled user to effectively “power up” the combination smartcard while biometrically authenticating as a “contact” smartcard on ingress to a controlled facility, simultaneous with user card insertion into an ingress contact card reader, allowing the batteryless smartcard of the present invention to draw electrical power from the reader, via power contacts aboard the smartcard. Alternatively, if the contact/contactless smartcard of the present invention is presented to an ingress smartcard reader which has built-in biometric authentication capabilities, the present invention can either (1) defer execution of biometric authentication to the biometrically authenticating smartcard reader; and/or (2) send a message to the biometrically authenticating smartcard reader stating that “biometric authentication has already been performed”; and/or (3) take any other action specified by the controlled facility.

When first used at the controlled facility (e.g., at door entry card reader, or at a computer workstation card reader) the user must authenticate themselves (e.g., by biometrics such as fingerprints, etc.) so as to enable the use of their smartcard. This action both enables the contactless use of the smartcard and the biometrically-protected functions of the card when used as a contact smartcard (if any).

Again, it is emphasized, the contact/contactless smartcard of the present invention is indifferent as to whether it performs biometric authentication on the card, and/or on an external device. (e.g., an ingress smartcard reader) performs external biometric authentication.

Once authentication has been successfully completed, the combination smartcard is enabled to conduct contactless functions until subsequently disabled. In summary, the card can be disabled by contact or contactless use at an egress point in the controlled facility, or by “time-out” or other oversight mechanism. The mechanism by which the contactless functions are enabled or disabled can be by electrically switching the function on the card under the control of the biometric authentication circuitry, or, by denying contactless access functions at the security control panel when the user is detected to be out of the controlled facility or “time-out” has occurred.

When the user and their card leave the controlled facility or exit from predefined perimeters of the controlled facility—e.g., at a door equipped with a smartcard reader—the facility access control system (“security control panel”) receives a signal from the card reader that the user has exited and suspends the cardholder's access privileges until the user is biometrically re-authenticated. Either of these two methods—either electronically enabling the card, or suspending access privileges by means of signals sent by the control panel—can be used to effectuate desired security functions. Optionally, both methods can be employed to provide additional security in the form of a redundant check.

Other advantages of the present invention are that it uses no batteries and enables a smartcard to perform both biometric-enabled “contact” access control functions in an ingress card reader or other facility contact card readers, as well as perform “contactless” functions within the facility, once contactless functions are appropriately enabled.

### BRIEF DESCRIPTION OF THE DRAWINGS & REFERENCE NUMERALS

Brief Description of the Drawings:

FIG. 1: Contact Biometric Smartcard without Contactless Capability

FIG. 2: Contact Biometric Smartcard that Enables Contactless Capability

FIG. 3: Contact Biometric Smartcard with Independent Contactless Capability

FIG. 4A: Details of a Circuit-Switched Contactless Circuit Enablement

FIG. 4B: Details of an Antenna-Switched Contactless Circuit Enablement

FIG. 5: Floor plan of a Facility—Using a Contact Biometric Smartcard to Gain Access to a Facility and to Enable Contactless Capability

FIG. 6: Using a Contact Biometric Smartcard to Access a Computer and to Enable Contactless Capability

FIG. 7: Using the Contactless Smartcard Capability within the Facility

FIG. 8: Disabling the Contactless Capability upon Exit from the Facility

FIG. 9: Enabling Logical and Physical Access at a Facilities Security Panel

### REFERENCE NUMERALS

10 Card Body
12 Radio Frequency Antenna Loop
14 Radio Frequency Transponder
16 Non-volatile Semiconductor Switch to enable Contactless Capability
18 Biometric Authentication Module
20 Smartcard Contacts and Circuit Module
22 Smartcard Processor Chip on back of Smartcard Module
24 Circuit paths between Smartcard Module and Biometric Module
30 Fingerprint Sensor Chip on Biometric Authentication Module
32 Biometric Data Processor on Biometric Module
40 Radio Frequency Transponder and/or Communications Processor
42 Nonvolatile Switch
44 Driver for Nonvolatile Switch
46 Circuit path between Biometric Module and Nonvolatile Switch Driver
50 Floor plan of Typical Facility with Entrance and Computer Workstations
52 Biometric Smartcard
54 Smartcard Contact Reader at Door
55 Contactless Reader at Door
56 Facility Logical and Physical Access Control System
58 Entry Reader Signal Path to Report an Authenticated Biometric Smartcard
59 Panel Signal Paths to Authorize Access to Computer 62, 72 and Door 54
62 Computer Workstation with Contact Smartcard Reader
72 Computer Workstation with Contactless Smartcard Reader

### DETAILED DESCRIPTION OF THE INVENTION

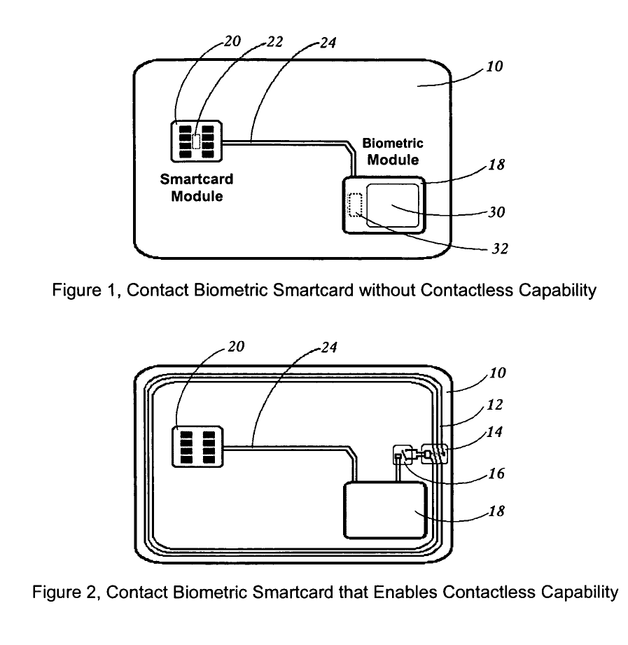

Referring now to FIG. 1, a biometrically-authenticated smartcard is shown. This version of a smartcard is implemented on underlying card body 10, and is equipped with smartcard chip and contacts 20, which is interconnected to biometric authentication module 18 by means of circuit path 24.

This card is enabled by an enrolled, authorized user presenting one or more “biometric credentials” by pressing their enrolled fingerprint(s) onto fingerprint sensor chip 30 situated on biometric authentication module 18. As is well-known in the art of biometric fingerprint authentication (e.g. such as disclosed in U.S. Pat. No. 4,582,985 to Lofberg), if the presented fingerprint is authenticated and verified as an enrolled fingerprint, module 18 generates and sends an actuating (enabling) signal (signifying “successful authentication completed”) to smartcard chip 20, thereby enabling standard smartcard functions. Biometric authentication module 18 performs fingerprint authentication (data processing, memory storage/retrieval, and other inherent functions) by means of its' embedded integral biometric data processor 32. Smartcard chip 20 can perform its' standard smartcard functions by means of its' embedded integral smartcard data processor 22. Alternatively, both processors could be implemented in the same common data processor (e.g., as described by U.S. Pat. No. 6,474,558 to Reiner, described herein).

FIG. 2 again shows the multifunctional present invention implemented on a card body 10. FIG. 2 depicts smartcard chip and contacts 20 connected to biometric authentication module 18 that includes fingerprint sensor 30. This configuration provides a biometrically-enabled smartcard using fingerprint verification, as a first step towards accessing the additional inventive features of the present invention. After the user successfully completes biometric authentication at the “contact” smartcard reader (i.e., during card insertion at the reader while the user is entering the controlled facility), the card's contactless communications capabilities can be enabled. The circuit for actuating/enabling card contactless capabilities, can (e.g.) deploy a non-volatile semiconductor switch (and/or other nonvolatile analog switch) that toggles into “ON” position, after successful user authentication at a contact ingress reader. At time of ingress and card insertion into the “contact” smartcard reader, the contact reader can impart an electrical charge to the card for capacitive storage in the card to supplant need for a battery within the card. These are only basic examples of customizable capabilities of this invention; it can be readily understood that other operational scenarios can be implemented. It is emphasized, when an existing ingress smartcard reader has a biometric authentication capability, it may not be necessary to biometrically authenticate on the card of the present invention; however, in such a case, it may additionally be necessary to configure the authenticating reader to send a command to the present invention to enable “contactless” functions, but only after the prospective user has been successfully biometrically authenticated.

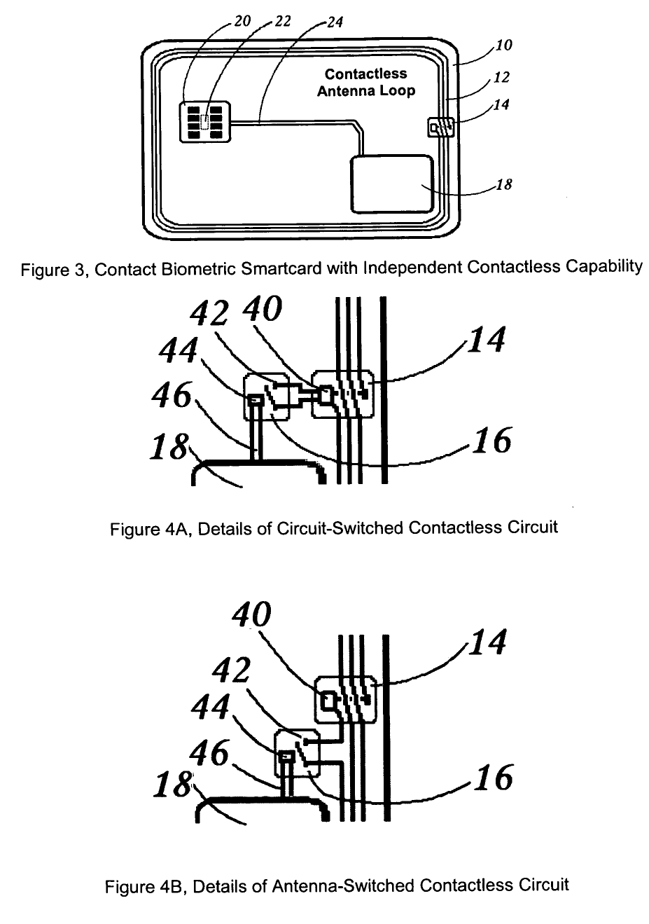

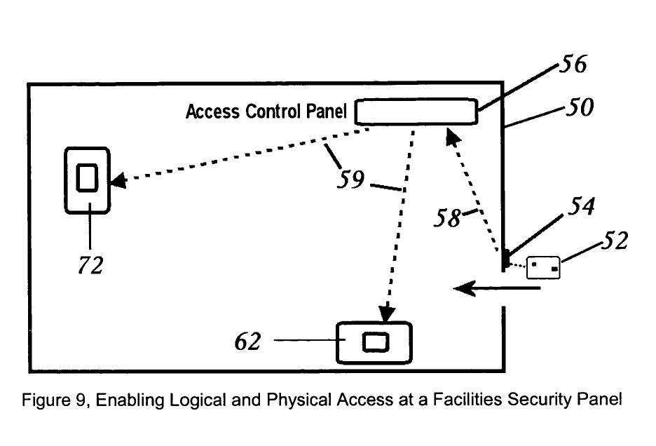

FIG. 3 shows another version of a smartcard implemented on a card body 10 which includes two forms of functionality. This smartcard has a “contactless” communication subsystem having wireless communications capabilities, enabled by means of loop antenna 12 and associated transponder 14 both of which are electrically independent of the biometric authentication module 18 and smartcard contacts and circuit module 20. FIG. 3 represents a variant of the invention in which a security access control system (such as security panel 56, shown in FIG. 9) performs the functions of logically disabling the equipment controlled by the contactless functions. Essentially, the difference between FIG. 2 and FIG. 3 can be summarized as follows: FIG. 2 shows a card of the present invention which enables its' contactless functions at time of ingress after the biometrically authenticated user has successfully completed authentication. FIG. 3 shows a variant of the card of the present invention which can have its' contactless features enabled at the smartcard reader and/or enabled/disabled by a security access control system (e.g., security control panel 56 of FIG. 9).

FIG. 4A shows additional details pertaining to FIG. 2, including radio frequency transponder processor 40 (integral to radio frequency transponder 14), nonvolatile analog switch 42, nonvolatile analog switch driver 44, and circuit path 46 between module 18 and switch driver 44. In operation, the enrolled user is fingerprint-authenticated at sensor 30 integral to biometric authentication module 18. Upon successful user authentication, one or more “authentication completion” signals can be generated: (e.g.) one “authentication completion signal” is sent via circuit path 24 to smartcard module 20 to actuate and enable secure functions of the processor 22 within it, and (e.g.) a second “authentication completion signal” is sent via circuit path 46 to nonvolatile analog switch driver 44, which activates processor 40, either by direct electrical input to the processor 40 or via a switch 42.

FIG. 4B is identical to FIG. 4A except that nonvolatile analog switch 42 when enabled can be placed in series with an antenna loop, such as antenna loop 12 of transponder 14, in lieu of (e.g.) enabling of a processor (such as processor 22, shown in FIG. 4A). This “antenna/loop enablement” embodiment described, enables usage of an antenna/transponder which does not otherwise have any “enable” input. When nonvolatile switch 42 is open, the contactless circuit is disabled, however, when switch 42 is closed, the transponder and antenna circuit operates normally, thereby enabling “contactless” functionality.

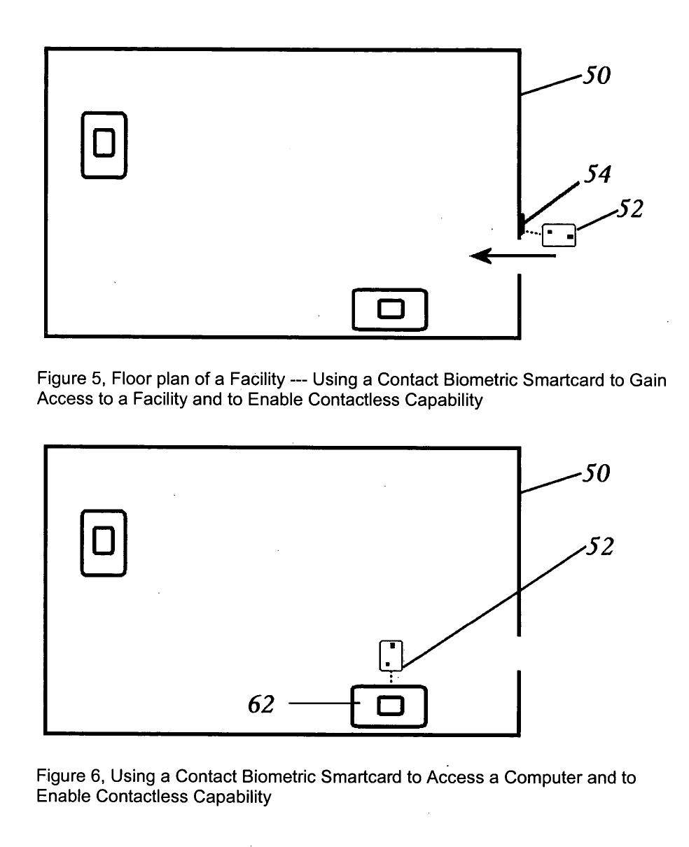

FIG. 5 shows an example of a facility floor plan 50, with an entrance and two computer stations. Floor plan 50 depicts a security and access system where user/card biometric authentication at “contact” card reader 54 permits a biometrically-authenticated user to initially access the controlled facility—and as a result of that successful access—be subsequently granted access to intra-facility “contactless” interfaces, so long as the user remains within predefined perimeters of the controlled facility where the user has privileges, and remains within other (individually-assigned) specified security parameters. More specifically, at the entrance to the controlled facility, the user authenticates biometrically upon insertion of smartcard 52 into contact reader 54, as described elsewhere herein.

FIG. 6 shows how a card's contactless functions can be enabled in the event that a smartcard-controlled door access control mechanism is not implemented (as is possible in some configurations). In such a case, contactless functions (e.g.) can be enabled by biometrically authenticating card 52 while it is inserted into a contact smartcard reader at a computer workstation 62.

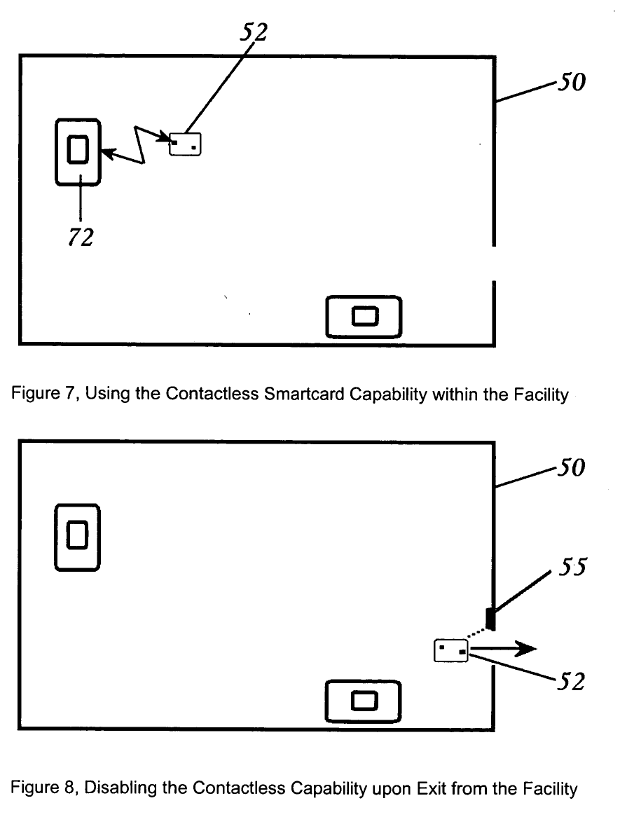

FIG. 7 shows the use of the contactless functions of the card to enable access to computer workstation 72. In this case, smartcard 52 has already been enabled, and now can be brought within proximity of a contactless smartcard reader (not shown) smartcard in order to gain access to the computer workstation 72.

FIG. 8 depicts a “user/card egress from controlled facility” scenario. A biometrically-authenticated user, operating smartcard 52 has just finished work for the day, and is now in the process of leaving the controlled facility. The user leaves the facility, using the exit monitored by contact or contactless smartcard reader 55. It is assumed that the contactless features of smartcard 52 are still enabled as the departing user approaches reader 55 which stands next to the portal of egress. At this point, contactless capabilities of the card can be disabled either by the contact smartcard reader upon egress, and/or they can be disabled by a wireless “disable signal” transmitted by reader 55, while the user is exiting the facility. Alternatively, the contactless functions of smartcard 52 can be disabled based on the expiration of a predefined time period (e.g., the length of a standard workday).

FIG. 9 illustrates the use of a facilities access control system (such as security panel 56) to enable access control functions at local computers, facility doors, and/or other facility equipment. FIG. 9 represents an alternative technique to electronically and/or wirelessly enable “contactless” functions on the smartcard of the present invention, by using one or more units of the security control panel 56.

The access control system offers overriding security, control, and monitoring. The system can be organized to monitor and control access to any or all of the facility's access events shown in FIGS. 3, 4a, 4b, 5, 6, 7, and 8. As a counterpoint, it must be observed that the card version of the present invention (shown in FIG. 2) is not controllable by an over-riding security control system (such as panel 56), because a facility which uses the card version of FIG. 2 does not implement a security control system which interfaces therewith.

In summary, FIG. 9 introduces the general concept of a facility-wide, centralized security system monitor. te: FIG. 9 depicts a one unit, “central-network-control” system panel implementing “facility-wide” security. (In other scenarios, multiple-unit distributed and/or central control systems (not shown) can communicate, and/or interoperate in large facilities, and/or be implemented in multiple, hierarchical access control layers. One or more units of physical access control panel 56 can serve as “facility master(s)”, and all contact and/or contactless card readers in the facility (or facility segment) are “slaves”. Details of master/slave relationships between access control panels such as panel 56 and card readers such as reader 54, depend on customization details implemented by a facility system administrator or facility security officer. In practice, some facilities or facility segments, require more or less security than others. In cases where multiple layers of security exist—and/or where multiple users with multiple different levels of security clearance exist—various security levels implement (enable or permit) different access control and monitoring features.

In operation, upon entry into a controlled facility with an access control panel 56, the user with smartcard 52 authenticates his/her identity at card reader 54. This successful authentication event triggers a request for access privileges from access control panel 56. Arrow 58 represents the communications path by which this event is triggered. Access control panel 56 looks up the privileges of the user of card 52, which may include user's level of clearance, for example, and determines if they include granting access to the door (shown open) next to card reader 54 and contactless workstation 72. If access to the door at reader 54 is granted, then this door can be opened. If access to workstation 72 is allowed by the access control panel 56, then the presence of the card at the contactless reader at workstation 72 will cause the workstation to become accessible. Workstation 62 represents and example of equipment that requires a higher degree of security, requiring the user to biometrically authenticate before use. Because workstation 62 has a contact smartcard reader, the user can be required to biometrically authenticate a finger in order to gain access.

Upon the egress of card 52 (as originally shown in FIG. 8) or other disablement (e.g., time-out) the access control panel 56 would send a disable message to computer workstation 62 and 72, along the same paths indicated by arrows 59. This prevents the use of the card by unauthorized users within the facility until the authorized cardholder is biometrically authenticated upon reentry.

It is easy to see that many different control scenarios can be implemented, from simple to complex, using one control panel (shown) or multiple control panels (not shown).

It may be sufficient for the card to provide an electrically-enabled contactless function, or to provide an access control panel mechanism to control the acceptance of the contactless card as described above. However, for additional security, both electronically-controlled contactless functions and access control panel capabilities may be combined in the same system. This type of customizable security system overlay provides redundant control of the contactless functions, in case one or the other security mechanisms fail or are defeated by an adversary.

In more detail, it can be observed that the user faces additional security control points in this combined “belt and suspenders” model. If card 52 fails to be disabled electronically within the card, then the access control system will still prevent its' unauthorized use. Conversely, if the access control panel fails to disable the card's acceptance (i.e., false acceptance) at the workstations 62 and 72, then the facility can still be protected by the electronic disablement of the contactless functions within the card.

It is important to note, that only a few configurations of the present invention are explicitly shown herein, but the present invention is not limited only to explicit configurations discussed herein. Additionally, it is important to note, while only “one user” or “one biometrically authenticated” user are often referred to herein, any number of users can be enrolled in their own smartcards, and all such users can be enrolled in any particular controlled facility. Furthermore, each card can have one or more users enrolled, where applicable. Also, the inventor anticipates that one or more other types of biometric sensors may be usable in the present invention, e.g., such as a biometric voiceprint sensor, or any other biometric sensor which can be implemented in a card-sized form factor.

We claim:

1. A smartcard apparatus having contact and contactless functions, comprising:
a card body;
a biometric sensor mounted to said card body for biometrically authenticating a user;
electrical contacts mounted to said card body; and
a wireless communications subsystem disposed within said card body, wherein said wireless communications subsystem and said contactless functions are operable only after said user has successfully biometrically authenticated to said biometric sensor with an ingress card reader.

2. The apparatus of claim 1, wherein said biometric sensor further comprises a biometric fingerprint sensor.

3. The apparatus of claim 1, wherein said wireless communications subsystem further comprises at least one transponder and at least one antenna for providing said contactless functions, and wherein said wireless communications subsystem further includes a rectifier circuit for deriving electrical power from a wireless RF signal source.

4. The apparatus of claim 1, wherein said biometric sensor further includes a biometric processor for processing biometric data.

5. The apparatus of claim 4, wherein said biometric processor is connected to a circuit switch interface for actuating and enabling said contactless functions.

6. The apparatus of claim 4, wherein said biometric processor is connected to an antenna switch interface for actuating and enabling contactless functions.

7. The apparatus of claim 1, wherein said contactless functions are only operable while said user is within a controlled facility.

8. The apparatus of claim 7, wherein said contactless functions are only available while said user is within areas of said controlled facility for which said user has access privileges.

9. The apparatus of claim 8, wherein said contactless functions are only available while said user is working within authorized time periods allowed by said controlled facility.

10. The apparatus of claim 9, wherein said contactless functions are only available while said user is accessing computer-based applications for which said user has access privileges.

11. The apparatus of claim 7, wherein said contactless functions are only available while said user is accessing at least one of physical resources for which said user has physical access privileges and logical resources for which said user has logical access privileges.

12. The apparatus of claim 1, wherein said smartcard is operational only for a predetermined period of time after each successful biometric authentication of said user.

13. A method for operating a biometrically authenticating contact/contactless smartcard, comprising steps of:
enrolling into said smartcard at least one fingerprint of an enrolled user authorized to use said smartcard and issuing said smartcard to said user;
requiring said enrolled user to present said at least one enrolled fingerprint to authenticate their identity with said smartcard prior to accessing a controlled facility and additionally requiring said enrolled user and said smartcard to simultaneously authenticate with a contact ingress smartcard reader;
permitting said enrolled user to access contactless functions of said smartcard only after said reader has enabled said contactless functions of said smartcard and only while said user and said smartcard are within the perimeter of said controlled facility; and
terminating contactless functions of said smartcard upon egress of said authorized user from said perimeter of said controlled facility.

14. An access control system for monitoring, controlling, and enabling contactless functions of at least one smartcard, comprising:
a contact/contactless smartcard adapted for operating as at least one of a contact and a contactless smartcard;
an enrolled biometrically-authenticated user; a contact ingress smartcard reader for providing electrical power to said smartcard;
a security control panel;
at least one of wireless communications and wired communications between said contact ingress smartcard reader and said security control panel; and
a verifying message sent from said contact ingress smartcard reader to said security control panel for verifying that said user has successfully biometrically authenticated to said fingerprint-enabled smartcard.
